(19) United States
(12) Patent Application Publication
(10) Pub. No.: US 2007/0289342 A1
(43) Pub. Date: Dec. 20, 2007

(54) ELECTRONIC RESTRAINT SYSTEM

(76) Inventors: Myron Tim Brooks, Ventura, CA (US); Andrew S. Naglestad, West Hills, CA (US)

Correspondence Address: MICHAEL BLAINE BROOKS, P.C., P.O. BOX 1630, SIMI VALLEY, CA, 93062-1630, US

(21) Appl. No.: 11/764,305

(22) Filed: Jun. 18, 2007

Related U.S. Application Data
(60) Provisional application No. 60/805,127, filed on Jun. 19, 2006.

(51) Int. Cl. E05B 75/00

(52) U.S. Cl. 70/16

(57) ABSTRACT

A combination mechanical and electronic lock system for use in cuffs and various other locking applications is disclosed. In the preferred embodiment, the lock is configured to receive a matching key that transmits a code that disengages the electronic lock from the mechanical lock so that the mechanical lock can be manually opened by the user. When implemented in a handcuff, for example, the mechanical lock includes a single lock mechanism and a double lock mechanism; and at least one electronic lock configured to selectively unlock at least a portion of the mechanical lock upon receipt of the proper digital code from the cuff key. The power needed to operate the electronic lock, preferably a solenoid or other actuator, is received directly or indirectly from the cuff key so that the cuff need not possess a battery.

### CROSS-REFERENCE TO RELATED APPLICATION(S)

This application claims the benefit of U.S. Provisional Patent Application Ser. No. 60/805,127 filed Jun. 19, 2006, which is hereby incorporated by reference herein for all purposes.

### TECHNICAL FIELD

The invention generally related to a restraint system using electronic locks. In particular, the invention relates to handcuffs or shackles that incorporate a combination of mechanical locks and electronic locks for use with an electronic key.

### BACKGROUND

Since the invention of handcuffs in the early twentieth century, defeating its locking mechanism has posed a threat to law enforcement and the public more generally. Escaped prisoners are typically desperate to avoid recapture and may resort to violence in the process of fleeing authority. Cases in which prisoners have freed themselves from standard cuffs are all too common.

The design of the common cuff lock has changed little in seventy-five years and is well understood by those who seek to defeat it. In addition, the standard cuff key possesses a generic design and can be used to open most any set of handcuffs or leg restraints. Compounding the problem is the ready availability of the handcuff keys. Handcuff keys can be easily and inexpensively purchased at any American gun show, sporting goods store, or through the Internet.

Criminals have also learned to breach or bypass standard cuff locks even when in prison or jail. Cuff keys may be smuggled into the prison or a facsimile of a key hand crafted using a wide variety of materials on hand including scrap metal, paper clips, hairpins, toothbrushes, wood, and bone, for example.

There is therefore a need for a restraint system that employs a lock mechanism that is tamper-proof and a key that is both unique and difficult to improvise.

### SUMMARY

The invention features a combination mechanical and electronic lock system for use in cuffs and various other lock applications. In the preferred embodiment, the cuff is configured to receive a matching cuff key that transmits a code that disengages the electronic lock from the mechanical lock so that the mechanical lock can be manually opened by the user. The cuff, for example, comprises a mechanical lock including a single lock mechanism and a double lock mechanism; and at least one electronic lock configured to selectively unlock at least a portion of the mechanical lock upon receipt of the proper passcode from the cuff key. The power needed to operate the electronic lock, preferably a solenoid or other actuator, is received directly or indirectly from the cuff key so that the cuff need not possess a battery.

The cuff may include a solid state memory device, for example, to store at least one passcode for comparison with the received passcode from the cuff key. Additional passcodes may be uploaded to the cuff to permit different keys access to the cuff or different levels of access to the cuff. The cuff may also be configured to receive and retain a serial number identifying the key used to open or unlock the cuff. Similarly, the cuff may be uploaded with a black list passcode specifying a passcode that is not authorized to unlock the electronic lock. The passcode is preferably a digital code which can be processed with a digital micro-processor.

In another embodiment of the invention, the lock includes a cuff housing; a ratchet pivotably coupled to the housing; a lock mechanism configured to restrict rotation of the ratchet about the cuff housing; an electronic lock configured to restrict or otherwise prevent the lock mechanism from being unlocked without the appropriate electronic key; and a processor configured to: store at least one passcode; receive a passcode from a key; and unlock at least one of the one or more electronic locks if the received passcode matches the stored passcode. The lock mechanism may include what are referred to as a single lock mechanism and a double lock mechanism. The electronic lock may include a first electronic lock and a second electronic lock. The first electronic lock generally restricts movement of the single lock mechanism, and the second electronic lock restricts the movement of at least the double lock mechanism.

The single lock mechanism generally includes a pawl that is biased onto the ratchet. The teeth of the pawl and ratchet are engaged in such a manner that the ratchet cannot be opened or otherwise removed from a prisoner's wrist without the appropriate electronic key. The pawl can only be pulled away from the ratchet with a lifter arm when acted on by a key. The first electronic lock includes an actuator that prevents the lifter arm from disengaging the pawl from the ratchet when locked, and permits the lifter arm to disengage the pawl from the ratchet when unlocked. The double lock mechanism includes a bolt configured to prevent the pawl from disengaging the ratchet when locked, and permit the pawl to disengage the ratchet when unlocked. The second electronic lock includes an actuator configured to prevent the bolt from disengaging the pawl when the second electronic lock is locked, and permit the bolt to disengage the pawl when unlocked. As discussed above, the power required to drive the one or more actuators is derived from the key since the lock has no internal power source.

In another embodiment, the invention features an electronic lock having at least one actuator coupled to a mechanical lock; memory configured to store at least one passcode; and a processor configured to: receive a passcode from a key; compare the received passcode to the stored passcode; and activate the at least one actuator to unlock the mechanical lock, if the received passcode matches the stored passcode.

### BRIEF DESCRIPTION OF THE DRAWINGS

The present invention is illustrated by way of example and not limitation in the figures of the accompanying drawings, and in which:

FIG. 1 is a pair of electronic shackles;

FIG. 2 is an exemplary electronic cuff, in accordance with one embodiment of the present invention;

FIG. 3 is an exemplary electronic cuff key, in accordance with one embodiment of the present invention;

FIG. 4 is a partial cross section of an electronic cuff in a single lock configuration, in accordance with one embodiment of the present invention;

FIG. 5 is a partial cross section of an electronic cuff as the single lock is disengaged, in accordance with one embodiment of the present invention; and

FIG. 6 is a partial cross section of an electronic cuff in a double lock configuration, in accordance with one embodiment of the present invention.

### DETAILED DESCRIPTION OF THE PREFERRED EMBODIMENTS

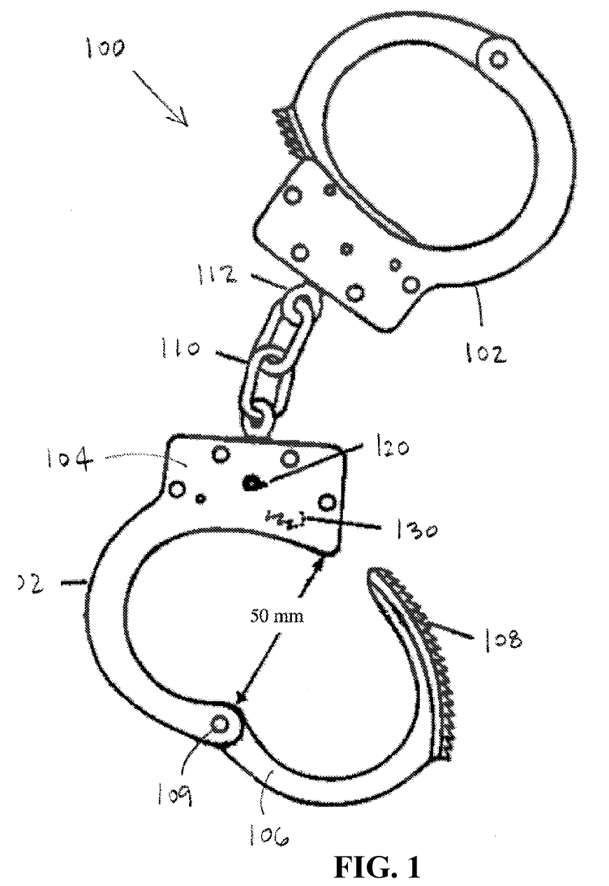

The preferred embodiment of the present invention is an electronic restraint system including an electronic shackle or cuff and corresponding electronic key. Illustrated in FIG. 1 is an electronic shackle 100 for enhancing the restraint of an individual and the safety of law enforcement personnel. The shackle 100 includes a pair of metal cuffs 102 or manacles adapted to encircle and confine the wrist or ankle of a person in the custody of law enforcement, this person being referred to herein as a prisoner. Each cuff 102 includes a cheek plate 104, ratchet 106 pivotably attached to the cheek plate by means of hinge 109, and a primary keyway 120 configured to receive a cuff key. The cheek plate 104 conceals a pawl with teeth 130 that engage the teeth 108 of the ratchet 106. The cuffs 102 are flexibly coupled together with a chain 110 or bolt and swivel eyes 112 to bind the prisoner's wrists or ankles together.

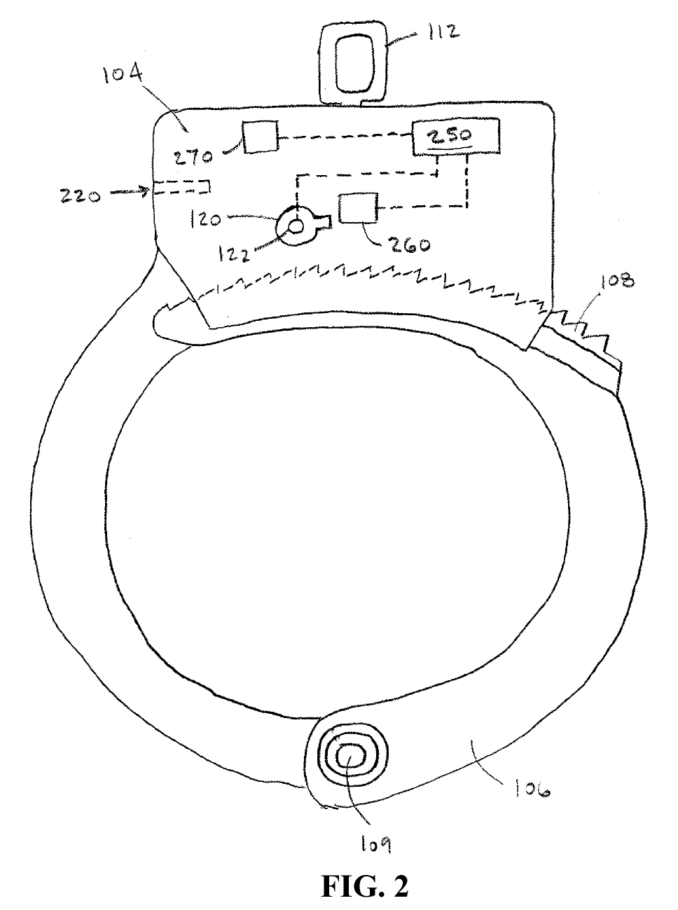

Referring to FIG. 2, each cuff 102 comprises a cheek plate 104 of hardened-steel for housing one or more mechanical and electronic locks, a ratchet 106 rotatably attached to the cuff housing by means of a pivot point 109, a primary keyway 120 sized to receive a cuff key to disengage a single lock mechanism and double lock mechanism, and a secondary keyway 220 sized to receive the pin of a cuff key to engage the double lock mechanism. In accordance with some embodiments, the cuff further incorporates one or more electronic locks including a first electronic lock 260 and a second electronic lock 270, each of which is electrically coupled to a passcode processor 250 protectively concealed within the cuff.

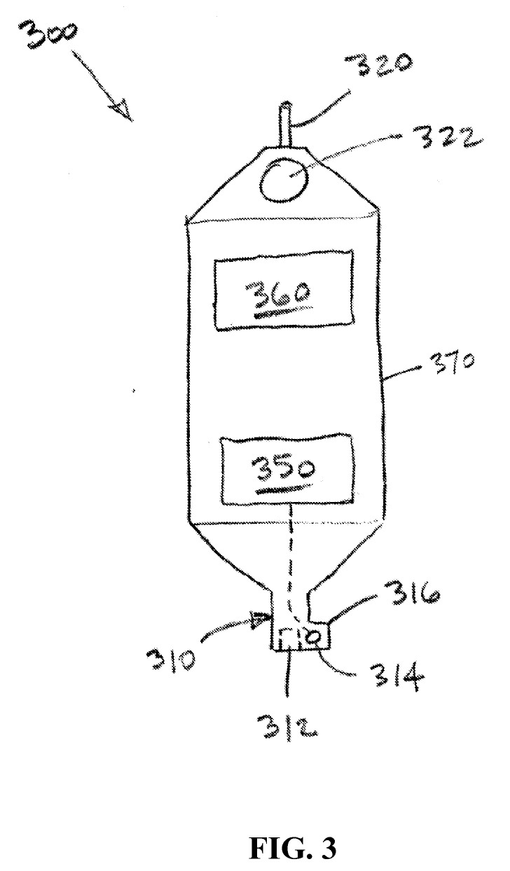

Illustrated in FIG. 3 is an exemplary cuff key 300, which functions at both a mechanical level and an electrical level to open the electronic restraint system. In the preferred embodiment, the lower portion 310 of the cuff key comprises a form of barrel key with a hollow, cylindrical shaft 312 and a rectangular tooth or bit 316. The barrel 310 is sized to fit within the primary keyway 120 and over a protrusion 122 that juts into the primary keyway from the inside of the cuff. The rectangular tooth or bit 316 is configured to turn within the cuff housing and unlock the single lock and double lock mechanisms. In addition, the upper portion of the cuff key includes an eye hole 322 and a pin 320 adapted to engage the double lock mechanism and the second electronic lock when inserted into the second keyway 220. The central portion of the cuff key includes a passcode generator 350 for communicating an internal passcode to the cuff as well as a battery 360 configured to provide operational power to the passcode generator 350, the passcode processor 250, the first electronic lock 260, and the second electronic lock 270.

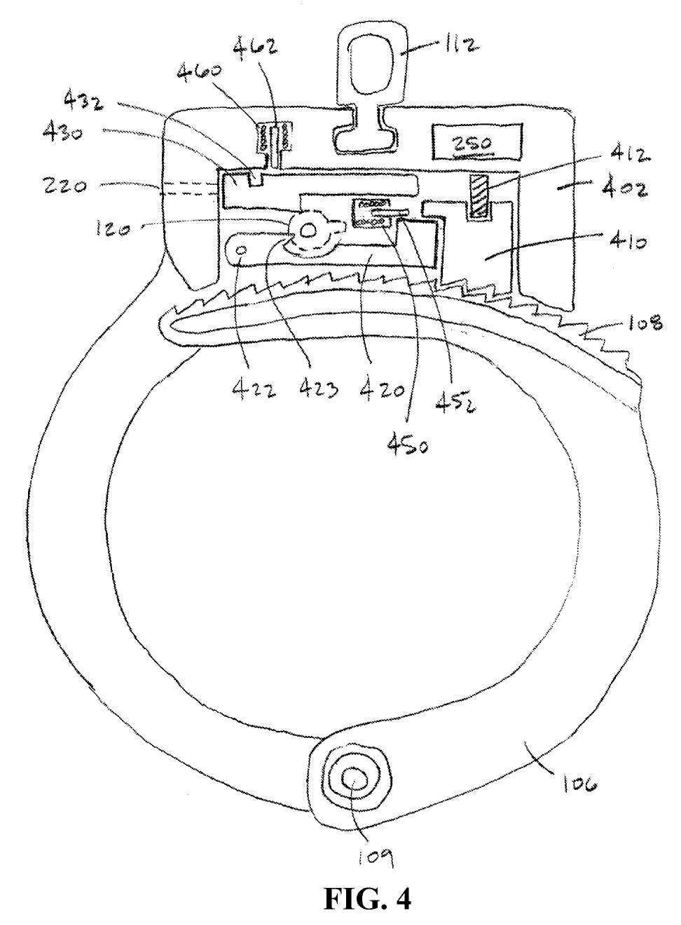

Illustrated in FIG. 4 is a partial cross section of a cuff with the single lock mechanism engaged (i.e., locked) and the double lock mechanism disengaged (i.e., unlocked). The cuff includes a housing defined by wall 402, a ratchet 106, a pawl 410 with spring 412, a lifter arm 420, and a bolt 430. Consistent with a conventional cuff with the single lock engaged, the spring 412 continually biases the pawl 410 downward toward the ratchet 106. The pawl 410, however, may be raised upward when the ratchet 106 is closed if and when the slopped faces of the ratchet's teeth 108 are forced from right to left. As such, the single lock mechanism of the present embodiment allows the ratchet 106 to freely rotate in a closing direction (counter-clockwise about hinge 109) toward the housing to enable law enforcement personnel to quickly immobilize a prisoner's wrist or ankle, for example. Due to the asymmetric shape of the teeth on the ratchet and pawl, however, the single lock mechanism generally prevents the ratchet 106 from rotating in an opening direction (clockwise) unless the single lock mechanism is first disengaged with the cuff key 300.

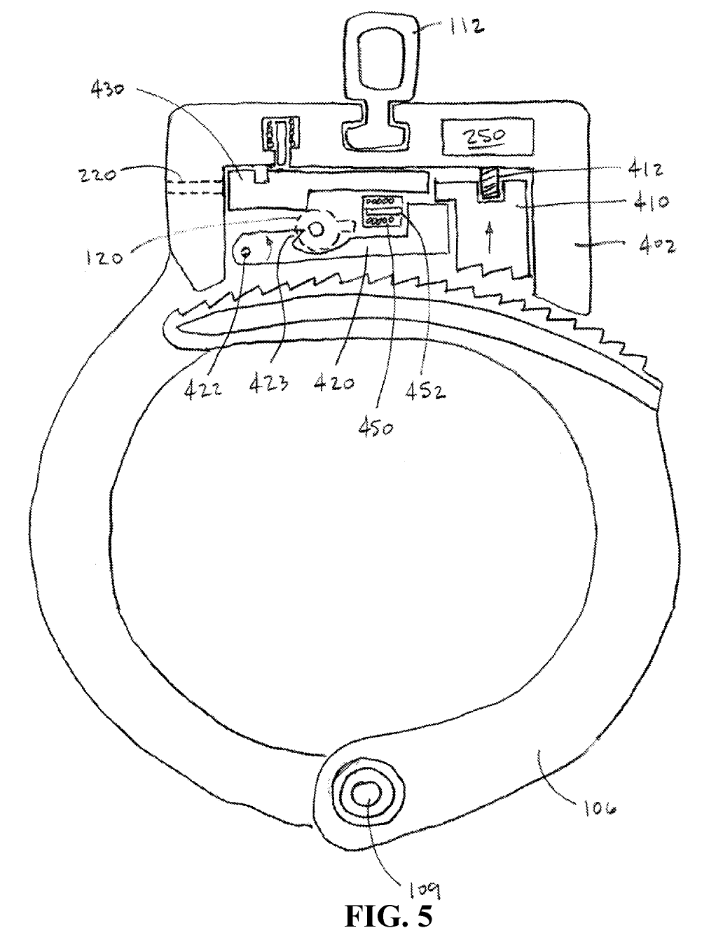

Illustrated in FIG. 5 is a partial cross section of a cuff 102 as the single lock is disengaged. To mechanically disengage the single lock, the cuff key is inserted into the first keyway 120 and the key turned clockwise to engage a flange 423 on the lifter arm 420. When turned beyond about 135 degrees, the key's bit 316 pulls the lifter arm 420 away from the ratchet 106 in a generally upward direction. When a torque sufficient to compress the spring 412 is applied, the lifter arm 420 pivots counter-clockwise about its axis 422, which causes the distal end at the right to push the pawl 410 upward away from the ratchet.

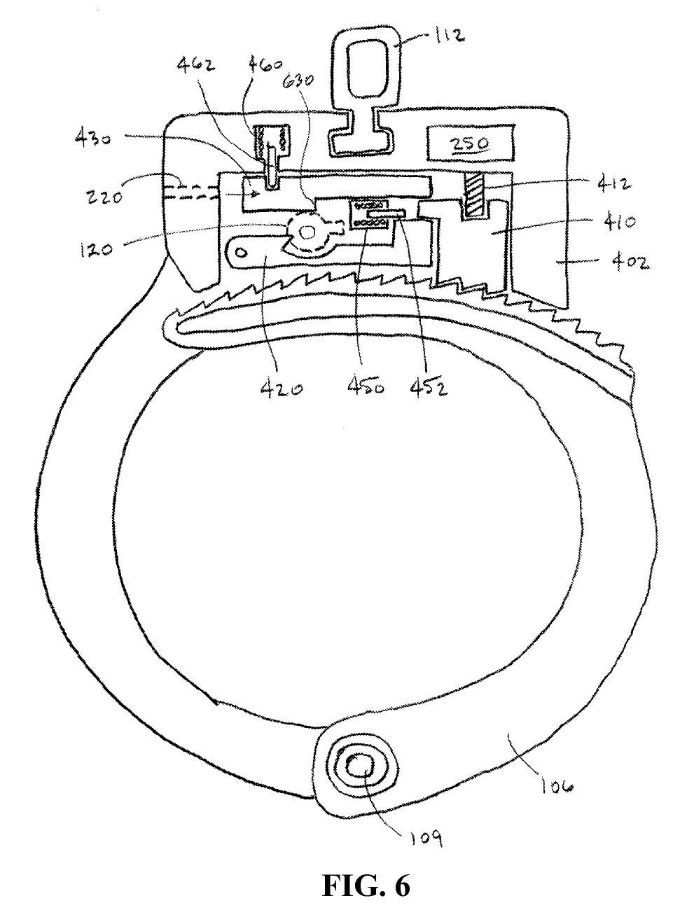

The preferred embodiment of the cuff further includes a double lock mechanism for added security. Illustrated in FIG. 6 is a partial cross section of a cuff with both the single lock mechanism and double lock mechanism engaged. The double lock is engaged by inserting the cuff key's pin 320 into the secondary keyway 220 to push the bolt 430 to the right into a position directly between the pawl 410 and housing wall 402, thereby preventing the pawl from being lifted away from the ratchet 106. As such, the pawl 410 is held in place to prevent the ratchet 106 from either opening (loosened) or closing (tightened) until the double lock is subsequently disengaged. To disengage the double lock, the same cuff key used for the single lock is inserted into the primary keyway 120 and turned counter clockwise (opposite direction needed to unlock the single lock mechanism), which pushes the bolt 430 back to the left when the key's bit 316 engages a flange 630 on the bolt 430. When pushed back to its initial station, the bolt 430 is once again clear of the pawl 410 to permit the pawl to retract from the ratchet 106.

The cuff 102 of the preferred embodiment further includes a first electronic lock 260 and a second electronic lock 270. The first and second electronic locks are configured to cooperate with and reinforce the single and double lock mechanisms, respectively. Both electronic locks are connected to the passcode processor 250 configured to compare the passcode received from a key to a stored passcode before disengaging the electronic locks. The passcode is communicated to the processor 250 by means of one or more electrical contacts 314 in the cuff key's bit 316 and corresponding electrical contacts in one or more of the keyway 120, 220. When the first electronic lock 260 is engaged, for example, the single lock mechanism can only be opened when the processor 250 receives the proper security code from a cuff key inserted into the primary keyway 120. The electronic cuff cannot, therefore, be opened by a standard cuff key even though it possesses the same physical shape and dimensions as the electronic cuff key 300 depicted in FIG. 3.

The first electronic lock 260 is automatically engaged when the single lock mechanism is engaged (i.e., when the ratchet engages the pawl), and automatically disengaged when the proper key is inserted and/or turned clockwise in the primary keyway 120. Similarly, the second electronic lock 270 is automatically engaged when the double lock mechanism is engaged via the second keyway 220 (i.e., when the bolt is slid behind the pawl), and automatically disengaged when the proper key is inserted and/or turned counter-clockwise in the first keyway 120.

Referring to FIG. 4 again, the first electronic lock 260 includes a first actuator while the second electronic lock 270 includes a second actuator, both of which are connected to the passcode processor 250. In the preferred embodiment, the actuators are electromagnetic solenoids although various other types of linear and rotary actuators known to those skilled in the art may be employed. The first actuator includes a coil 450 and a retractable projection 452. When engaged, the projection 452 extends into the path of the lifter arm 420, thereby preventing the lifter arm from pulling the pawl 410 away from the ratchet 106.

Referring to FIG. 5 again, if and when the first electronic lock is disengaged, the processor 250 applies a power signal to the first solenoid 260, which causes the projection 452 to be temporarily retracted. When retracted, the lifter arm 420 may be turned counter-clockwise and the pawl 410 lifted. Without the proper key, the projection 452 remains extended to prevent a key from turning the lifter arm 420 to open the ratchet.

Referring to FIG. 6 again, the second solenoid 270 also includes an electromagnetic coil 460 and a projection 462 adapted to physically obstruct the bolt 430 from sliding in an unlocking direction without the proper cuff key. If and when the second electronic lock is disengaged, the processor 250 applies a power signal to the second solenoid 270, which causes the projection 462 to be retracted from a recess in the bolt. With the projection 462 clear of the bolt 430, the bolt may be manually slid to the left and clear of the pawl 410. Without the proper key, the projection 462 secures the bolt 410 to prevent a key from disengaging the second lock mechanism.

In accordance with some embodiments, the power to actuate the first and second solenoids is provided by the cuff key 300, which includes a portable energy source including one or more batteries 360. The power signal may be transmitted serially after the passcode is transmitted to the cuff 102, transmitted in parallel via a second channel operably coupling the key and passcode processor, or communicated to the cuff via a capacitive or inductive link. The cuff 102 in the preferred embodiment, however, does not include any internal energy source.

The passcode processor 250 in the preferred embodiment is a solid state micro-processor such as a Programmed Integrated Circuits (PIC), for example. The processor authenticates the passcode by comparing the passcode received from the key to one or more approved passcodes retained in on-board memory in the cuff's passcode processor 250, for example. A passcode is preferably a 256 or 512 bit digital code or combination representing an alphanumeric string of characters. The passcode may be stored to on-board memory when the cuff is manufactured; programmably written to memory using an erasable programmable read-only-memory (EPROM), for example; or a combination thereof.

The set of passcodes with which the cuff 102 can be opened may consist of a single passcode associated with one or more keys, or comprise multiple passcodes associated with different geographic areas or the different levels of a law enforcement organization. For example, there may be a first passcode associated with the key of an officer; a second passcode associated with a local law enforcement department, a third passcode associated with a county law enforcement department; a fourth passcode associated with a state law enforcement department; or any combination of the above. This avoids the problems associated with the universal key in traditional cuffs. The preferred embodiment also isolates problems due to lost keys, for example, since the loss of a key used in one police department does not affect another department using a different passcode.

In some embodiments, the cuff 102 is further adapted to retain a black list including passcodes that are barred from unlocking the cuff, thereby providing a mechanism for neutralizing the passcodes associated with keys that are lost or stolen, for example. The authorized passcodes and black list codes may be periodically uploaded to the cuff using a docking station, such as a cradle maintained by the law enforcement office or manufacturer.

The electronic cuff key 300 in the preferred embodiment comprises a traditional skeleton key or barrel key with one or more bits 316 having one or more electrical contacts 314; a memory for retaining one or more passcodes; a processor 350 or circuit board for generating the passcode; one or more batteries 360 or other power source; and a cylinder 370 to house the batteries. The key 300 should be sufficiently large to prevent a stolen key from being easily concealed by a prisoner during a pat-down search, for example. This may be effectively achieved using a key with two or more AA or AAA batteries, for example. The key may have assigned to it a unique serial number that is also communicated to the cuff each time the cuff is unlocked.

In some embodiments, the cuff key 300 includes a miniature recharging apparatus in the key, the recharging apparatus being consistent with the recharger used in hands-free headsets for cellular phones. A light emitting diode may be used as a low battery charge level indicator, and/or an audible alert used to notify the user of a low battery charge level or malfunction. When low, the batteries can then be recharged with a AC to DC converter, which could save the law enforcement departments the expense of replacing batteries.

In some embodiments, the key and/or cuff includes a light emitting diode (LED) whose light level can be used to indicate to law enforcement personnel whether the first or second locking mechanism has been properly engaged and/or disengaged. Similarly, the cuff key 300 and/or cuff 102 may include an audible alarm for generating a beep to indicate when the electronic cuff is locked and/or unlocked.

In some additional embodiments, the cuff 102 is adapted to measure, record, and upload information about the cuff and key usage. Information indicating the degree to which the cuff is locked may also be recorded to enable law enforcement to reconstruct the conditions under which cuff was applied to a prisoner. That is, the cuff 102 is adapted to indicate the position of the ratchet relative to the housing, thus indicating how much or how little pressure was used to constrain the prisoner's wrist within the cuff. The position of the ratchet may be measured and recorded in terms of the number and position of the ratchet teeth 108 that engage the pawl 410 when the cuff is secured in the single or double locked position. The information may further include a timestamp and the information periodically uploaded to a cradle or docking station, for example.

The information recorded by the cuff for subsequent download may further include the serial number of the previous one or more keys used to unlock the cuff. This information may then be stored in the cuff and retrieved if necessary to identify which key was used to unlock the cuff, determine the identity of the person to whom the key was assigned, and whether the individual with the key was authorized to unlock the cuff.

The preferred embodiment of the invention herein is intended for use in a cuff or other restraint system. One skilled in the art, however, will appreciate that the invention is also applicable to numerous other locking applications including automobiles, homes, gates, filing cabinets, lock boxes, safes, chests, briefcases, padlocks, and trigger locks, for example.

Although the description above contains many specifications, these should not be construed as limiting the scope of the invention but as merely providing illustrations of some of the presently preferred embodiments of this invention.

Therefore, the invention has been disclosed by way of example and not limitation, and reference should be made to the following claims to determine the scope of the present invention.

We claim:

1. A cuff configured to connect to a cuff key, the cuff comprising:
a mechanical lock comprising a single lock mechanism and a double lock mechanism; and
at least one electronic lock configured to selectively unlock at least a portion of the mechanical lock upon receipt of a passcode from the cuff key.

2. The cuff of claim 1, wherein the at least one electronic lock comprises an actuator, and the actuator is configured to selectively unlock at least a portion of the mechanical lock using power originating from the cuff key.

3. The cuff of claim 1, wherein the cuff further comprises a memory.

4. The cuff of claim 3, wherein the memory is configured to store at least one passcode for comparison with the received passcode from the cuff key.

5. The cuff of claim 4, wherein the memory is configured to store a plurality of passcodes authorized to unlock the at least one electronic lock.

6. The cuff of claim 3, wherein the memory is configured to store a cuff key serial number communicated to the cuff from the cuff key.

7. The cuff of claim 3, wherein the memory is configured to store at least one black list passcode not authorized to unlock the at least one electronic lock.

8. The cuff of claim 3, wherein the at least one electronic lock comprises one or more actuators configured to restrict movement of the mechanical lock.

9. The cuff of claim 1, wherein the cuff further comprises a passcode processor, and the passcode from the cuff key comprises a digital code.

10. A lock comprising:
a cuff housing;
a ratchet pivotably coupled to the housing;
one or more lock mechanisms configured to restrict rotation of the ratchet relative to the cuff housing;
one or more electronic locks configured to restrict at least one of the one or more lock mechanisms from being unlocked;
a processor configured to:
a) store at least one passcode;
b) receive a passcode from a key; and
c) unlock at least one of the one or more electronic locks if the received passcode matches the stored passcode.

11. The lock of claim 10, wherein the one or more lock mechanisms comprise a single lock mechanism, and the one or more electronic locks comprise a first electronic lock.

12. The lock of claim 11, wherein the one or more lock mechanisms further comprise a double lock mechanism, and the one or more electronic locks further comprise a second electronic lock.

13. The lock of claim 12, wherein the first electronic lock restricts movement of the single lock mechanism, and the second electronic lock restricts movement of the double lock mechanism.

14. The lock of claim 11, wherein the single lock mechanism comprises:
a) a pawl biased toward the ratchet; and
b) a lifter arm adapted to disengage the pawl from the ratchet.

15. The lock of claim 14, wherein the first electronic lock comprises a first actuator configured to:
a) prevent the lifter arm from disengaging the pawl from the ratchet when locked; and
b) permit the lifter arm to disengage the pawl from the ratchet when unlocked.

16. The lock of claim 12, wherein the double lock mechanism comprises a bolt configured to:
a) prevent the pawl from disengaging the ratchet when locked; and
b) permit the pawl to disengage the ratchet when unlocked.

17. The lock of claim 15, wherein the second electronic lock comprises a second actuator configured to:
a) prevent the bolt from disengaging the pawl when locked; and
b) permit the bolt to disengage the pawl when unlocked.

18. The lock of claim 10, wherein the one or more electronic locks comprise one or more actuators configured to receive power provided by the key.

19. The lock of claim 18, wherein the lock has no internal power source.

20. An electronic lock comprising:
at least one actuator coupled to a mechanical lock;
memory configured to store at least one passcode; and
a processor configured to:
a) receive a passcode from a key;
b) compare the received passcode to the stored passcode; and
c) activate the at least one actuator to unlock the mechanical lock if the received passcode matches the stored passcode.
